(19) United States
(12) Patent Application Publication
(10) Pub. No.: US 2025/0260245 A1
(43) Pub. Date: Aug. 14, 2025

(54) BATTERY STRING PRE-CHARGE OPERATION

(71) Applicant: Caterpillar Inc., Peoria, IL (US)

(72) Inventors: Amit SHARMA, Dunlap, IL (US); Avinash DONGARE, Bangalore (IN); Hua XU, Dunlap, IL (US); Robert David BUSBY, Whittlesey (GB)

(73) Assignee: Caterpillar Inc., Peoria, IL (US)

(21) Appl. No.: 18/437,998

(22) Filed: Feb. 9, 2024

(51) Int. Cl. H02J 7/00; H01M 10/42; H01M 10/44; H01M 10/46; H01M 10/48

(52) U.S. Cl. CPC H02J 7/0029; H01M 10/4257; H01M 10/441; H01M 10/46; H01M 10/482

(57) ABSTRACT

In some implementations, a controller may select, using one or more selection criteria, a first battery string, from multiple battery strings of a battery pack, for a pre-charge operation of the battery pack. The controller may detect a failure of the pre-charge operation via a first pre-charge circuit of the first battery string. The controller may select, using the one or more selection criteria, a second battery string, from the multiple battery strings, for the pre-charge operation based on the failure meeting one or more failure conditions. The controller may perform, via a second pre-charge circuit of the second battery string, the pre-charge operation. The controller may configure the first battery string for operation based on the pre-charge operation via the second battery string being successful.

### TECHNICAL FIELD

The present disclosure relates generally to battery systems and, for example, to a battery string pre-charge operation.

### BACKGROUND

A battery system may include a battery pack that includes one or more battery cells. A machine may include one or more battery packs to provide power to components of the machine, such as lights, computer systems, and/or a motor, among other examples. As another example, a battery pack may store energy generated by a machine. In some examples, a battery pack may include one or more battery strings. A battery string includes a set of battery cells and/or battery modules electrically connected to each other (e.g., in series or in parallel). When connecting to a load, a battery pack may experience inrush currents. An inrush current is a sudden surge of current that can occur when a load is initially connected to a power source. Inrush currents can overload components of the battery pack and cause damage to electrical components in one or more circuits of the battery pack.

To mitigate the problems caused by inrush currents, a pre-charge operation may be used. Pre-charging involves gradually applying voltage to the load, allowing the voltage of components to stabilize and reducing the impact of inrush currents (e.g., by bringing a voltage of a load close to a voltage level of the battery pack and/or one or more battery strings). By implementing a controlled pre-charge operation, the risks associated with sudden and high inrush currents can be minimized. To perform a pre-charge operation, the battery pack may include a pre-charge circuit (e.g., that includes one or more resistors, one or more switches, and/or a controller). The pre-charge circuit may control a gradual increase in voltage. For example, one or more resistors in the pre-charge circuit limit the rate at which voltage is applied to the load to allow for a controlled increase in voltage. After the voltage across the load reaches a defined level and stabilizes, the pre-charge operation is completed and the battery pack and/or battery string may be brought online (e.g., the battery pack and/or battery string may operate at the nominal battery voltage). However, in some cases, a battery pack may include a single pre-charge circuit and all battery strings may be pre-charged together. Therefore, if there is a failure of the pre-charge operation, the battery pack and/or a battery string (e.g., used for pre-charging) may not be usable until the issue that caused the failure is resolved.

Patent Cooperation Treaty (PCT) patent application No. WO2012/158, 185 (the '185 application) discloses an energy module that includes a plurality of battery strings, each battery string supported by a rack. The energy module has redundant pre-charge capability. For example, two of the racks, such as racks 1 and 2, are provided with pre-charge capabilities. A controller of the energy module may attempt pre-charging using the rack 1. If the rack 1 pre-charge is not ok, then the controller determines that the rack 1 pre-charge has failed. Since both rack 1 and rack 2 have pre-charge capabilities, the controller then closes the contactors for rack 2. The controller then determines whether the rack 2 pre-charge is ok. If the rack 2 pre-charge fails, a fault is set. If the rack 2 pre-charge is okay, the controller closes contactors of rack 1. Rack 2 which has been now pre-charged is then used to charge rack 1. Since rack 2 is already open, the controller next closes the rack 3 contactors. The controller then orderly and sequentially opens the remaining rack contactors until the last rack (rack N) contactors are closed. Once all the rack contactors are closed to bring all the racks online, the controller closes the energy module contactors and ends the process.

However, the pre-charge operation disclosed by the '185 application still requires the rack 1 to be pre-charged prior to bringing the energy module fully online. Additionally, the '185 application discloses only two racks with pre-charging capabilities (where the energy module includes more than two racks) that are used to pre-charge the energy module regardless of conditions associated with the pre-charge operation. If both of the racks with pre-charge capabilities experience failure, then the pre-charge operation disclosed by the '185 application fails. Further, the pre-charge operation disclosed by the '185 application uses both of the racks with pre-charge capabilities regardless of conditions or prior failures of the pre-charge operation, which may result in damage to the energy module.

The battery pack and/or pre-charge operation of the present disclosure solves one or more of the problems set forth above and/or other problems in the art.

### SUMMARY

A battery pack may include multiple battery strings having respective pre-charge circuits; and one or more controllers configured to: select, using one or more selection criteria, a first battery string, from the multiple battery strings, for a pre-charge operation of the battery pack; detect a failure of the pre-charge operation via a first pre-charge circuit of the first battery string; select, using the one or more selection criteria, a second battery string, from the multiple battery strings, for the pre-charge operation if the failure does not meet one or more failure conditions; perform, using a second pre-charge circuit of the second battery string, the pre-charge operation; and configure the first battery string for operation if the pre-charge operation via the second battery string is successful.

A controller for a battery pack may include one or more memories; and one or more processors, communicatively coupled to the one or more memories, configured to: select, using one or more selection criteria, a first battery string, from multiple battery strings of the battery pack, for a pre-charge operation of the battery pack; detect a first failure of the pre-charge operation via the first battery string; perform a first re-attempt operation, using a second battery string of the multiple battery strings, for the pre-charge operation based on the first failure satisfying one or more failure conditions; and configure, if the pre-charge operation is successful via the second battery string, the first battery string and the second battery string for operation.

A method performed by a controller of a battery pack may include selecting, using one or more selection criteria, a first battery string, from multiple battery strings of the battery pack, for a pre-charge operation of the battery pack; detecting a failure of the pre-charge operation via a first pre-charge circuit of the first battery string; selecting, using the one or more selection criteria, a second battery string, from the multiple battery strings, for the pre-charge operation based on one or more failure conditions; performing, via a second pre-charge circuit of the second battery string, the pre-charge operation; and configuring the first battery string for operation based on the pre-charge operation via the second battery string being successful.

### BRIEF DESCRIPTION OF THE DRAWINGS

FIG. 1 is a diagram of an example battery pack described herein.

FIG. 2 is a diagram of an example pre-charge operation described herein.

FIG. 3 is a diagram of an example of one or more failure conditions described herein.

FIG. 4 is a flowchart of an example process associated with a battery string pre-charge operation.

### DETAILED DESCRIPTION

This disclosure relates to a battery system (such as a battery pack with multiple battery strings) which is applicable to any machine application that uses power provided by a battery. As used herein, “battery cell,” “battery,” and “cell” may be used interchangeably. As used herein, “machine” may refer to any machine that performs an operation associated with an industry, such as mining, construction, farming, transportation, or any other industry. For example, a machine may be an electric vehicle, a hybrid vehicle, a compactor machine, a paving machine, a cold planer, a grading machine, a backhoe loader, a wheel loader, a harvester, an excavator, a motor grader, a skid steer loader, a tractor, and/or a dozer, among other examples. Additionally, or alternatively, the battery system (e.g., the battery pack) described herein may be used in an energy storage application, such as for solar energy storage and/or wind energy storage, among other examples.

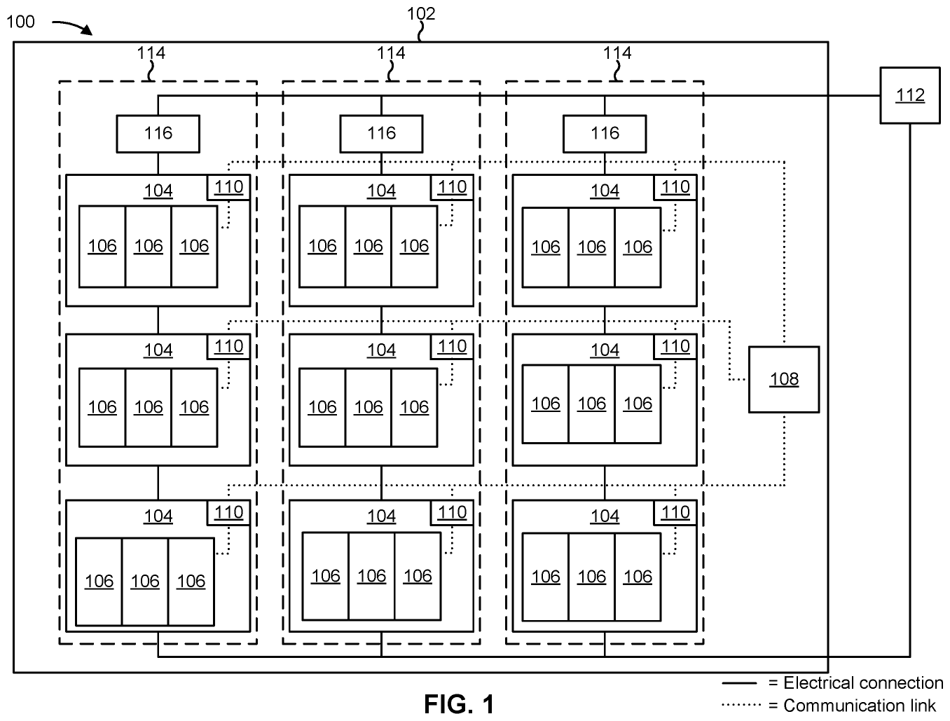

FIG. 1 is a diagram of an example battery pack 100. The battery pack 100 may include a battery pack housing 102, one or more battery modules 104, and one or more battery cells 106. The battery pack 100 includes a battery pack controller 108 associated with storing information and/or controlling one or more operations associated with the battery pack 100. Each battery module 104 includes a module controller 110 associated with storing information and/or controlling one or more operations associated with the battery module 104.

The battery pack 100 is associated with a component 112 (e.g., is electrically coupled to the component 112). The component 112 may be a machine. The component 112 may be powered by the battery pack 100. For example, the component 112 can be a load that consumes energy provided by the battery pack 100, such as electronics or an electric motor, among other examples. As another example, the component 112 provides energy to the battery pack 100 (e.g., to be stored by the battery cells 106). In such examples, the component 112 may be a power generator, a solar energy system, and/or a wind energy system, among other examples.

The battery pack housing 102 includes metal shielding (e.g., steel, aluminum, or the like) to protect elements (e.g., battery modules 104, battery cells 106, the battery pack controller 108, the module controllers 110, wires, circuit boards, or the like) positioned within battery pack housing 102. Each battery module 104 includes one or more (e.g., a plurality of) battery cells 106 (e.g., positioned within a housing of the battery module 104). Battery cells 106 may be connected in series and/or in parallel within the battery module 104 (e.g., via terminal-to-busbar welds). Each battery cell 106 is associated with a chemistry type. The chemistry type may include lithium ion (Li-ion) (e.g., lithium ion polymer (Li-ion polymer), lithium iron phosphate (LFP), and/or nickel manganese cobalt (NMC)), nickel-metal hydride (NiMH), or nickel cadmium (NiCd), among other examples.

The battery modules 104 are arranged within the battery pack 100 in one or more battery strings 114. The battery pack 100 includes multiple battery strings 114 (e.g., three battery strings 114 as shown in FIG. 1 as an example). The battery modules 104 of a battery string 114 are connected via electrical connections, as shown in FIG. 1. The electrical connections may be removable, such as via bolts and/or nuts at one or more terminals on housings of the battery modules 104. The battery modules 104 may be connected in series and/or in parallel. For example, a number of battery modules 104 may be connected in series to provide a particular voltage (e.g., to the component 112). Alternatively, a number of battery modules 104 may be connected in parallel in a battery string 114 to increase a current and/or a power output of the battery pack 100. The number of battery cells 106 included in each battery module 104, the number of battery modules 104 included in a battery string 114, and/or the number of battery strings 114 included in the battery pack 100 (e.g., and the relative serial and/or parallel connections of the battery cells 106 and/or the battery modules 104) may be associated with the required output power and an intended use of the battery pack 100. For example, any number of battery cells 106 can be included in a battery module 104. Similarly, any number of battery modules 104 can be included in a battery string 114. Any number of battery strings 114 can be included in the battery pack 100.

The battery pack controller 108 is communicatively connected (e.g., via a communication link) to each module controller 110. The battery pack controller 108 may be associated with receiving, generating, storing, processing, providing, and/or routing information associated with the battery pack 100. The battery pack controller 108 may also be referred to as a battery pack management device or system. The battery pack controller 108 may communicate with the component 112 and/or a controller of the component 112, may control a start-up and/or shut-down procedure of the battery pack 100, may monitor a current and/or voltage of a string (e.g., of battery modules 104), and/or may monitor and/or control a current and/or voltage provided by the battery pack 100, among other examples. A module controller 110 may be associated with receiving, generating, storing, processing, providing, and/or routing information associated with a battery module 104. The module controller 110 may communicate with the battery pack controller 108.

The battery pack controller 108 and/or a module controller 110 may be associated with monitoring and/or determining a state of charge (SOC), a state of health (SOH), a depth of discharge (DOD), an output voltage, a temperature, and/or an internal resistance and impedance, among other examples, associated with a battery module 104 and/or associated with the battery pack 100. Additionally, or alternatively, the battery pack controller 108 and/or the module controller 110 may be associated with monitoring, controlling, and/or reporting one or more parameters associated with battery cells 106. The one or more parameters may include cell voltages, temperatures, chemistry types, a cell energy throughput, a cell internal resistance, and/or a quantity of charge-discharge cycles, among other examples.

The battery pack controller 108 and/or a module controller 110 includes one or more processors and/or one or more memories. A processor may include a central processing unit, a microprocessor, a controller, a microcontroller, a digital signal processor, a field-programmable gate array, an application-specific integrated circuit, and/or another type of processing component. The processor may be implemented in hardware, firmware, or a combination of hardware and software. In some implementations, the processor may include one or more processors capable of being programmed to perform one or more operations or processes described elsewhere herein. A memory may include volatile and/or nonvolatile memory. For example, the memory may include random access memory (RAM), read only memory (ROM), and/or another type of memory (e.g., a flash memory, a magnetic memory, and/or an optical memory). The memory may include internal memory (e.g., RAM, ROM, or a hard disk drive) and/or removable memory (e.g., removable via a universal serial bus connection). The memory may be a non-transitory computer-readable medium. The memory may store information, one or more instructions, and/or software (e.g., one or more software applications) related to the operation of the battery pack 100, a battery module 104, and/or a battery cell 106. The memory may include one or more memories that are coupled (e.g., communicatively coupled) to the processor, such as via a bus. Communicative coupling between a processor and a memory may enable the processor to read and/or process information stored in the memory and/or to store information in the memory.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

As shown in FIG. 1, each battery string 114 includes a pre-charge component 116. For example, each battery string 114 included in the battery pack 100 may have a pre-charge capability. A pre-charge component 116 includes a pre-charge circuit. In some cases, a pre-charge component 116 includes a pre-charge controller. The battery string(s) 114 of the battery pack 100 have respective pre-charge circuits (e.g., have respective pre-charge components 116). A pre-charge component 116 is configured to gradually introduce power to a battery string 114 to prevent sudden inrush currents, voltage spikes, and/or other potential issues that can occur when power is applied instantly to the battery string 114. A pre-charge circuit may include one or more pre-charge resistors to limits the initial current flow when the pre-charge circuit is energized. A pre-charge circuit may include a pre-charge relay or contactor (e.g., to control the connection and disconnection of the pre-charge circuit). The specific components and/or arrangement of a pre-charge circuit can vary based on the application, the type of load (e.g., the type of component 112), and/or the desired level of control, among other examples.

As indicated above, FIG. 1 is provided as an example. Other examples may differ from what is described with regard to FIG. 1.

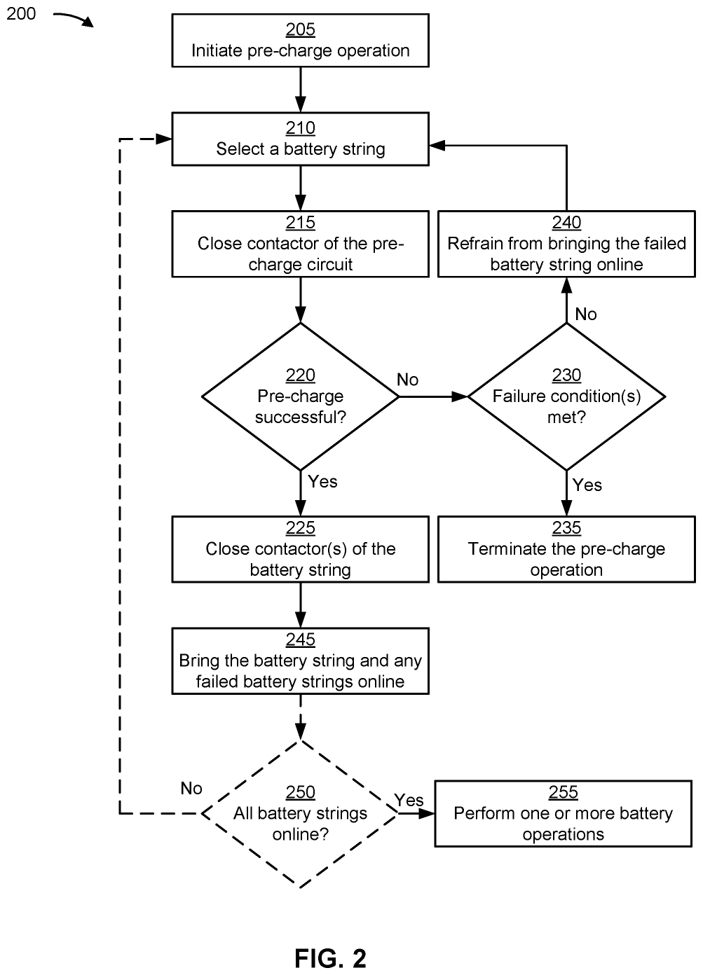

FIG. 2 is a diagram of an example pre-charge operation 200. The pre-charge operation 200 may be performed by the battery pack 100, one or more battery strings 114, the battery pack controller 108, one or more module controllers 110, and/or one or more pre-charge components 116, among other examples. For example, one or more operations described herein may be performed by, or caused by, the battery pack controller 108 or another controller.

As shown in FIG. 2, the pre-charge operation 200 may include initiating the pre-charge operation (block 205). For example, the battery pack controller 108 may initiate the pre-charge operation. The battery pack controller 108 may receive or obtain an indication of a battery operation to be performed in association with the component 112. For example, the battery operation may include a charging operation (e.g., associated with receiving power from the component 112 to be stored in the one or more battery cells 106) or a discharging operation (e.g., associated with providing power to the component 112 from the one or more battery cells 106).

The battery pack controller 108 obtains pre-charging information. The pre-charging information includes a voltage level of the component 112 (e.g., a voltage level of a load connected to the battery pack 100 and/or a machine-side voltage level). Additionally, the pre-charging information includes voltage levels of respective battery strings 114. For example, the battery pack controller 108 obtains a voltage level of each battery string 114 included in the battery pack 100.

The pre-charge operation 200 includes selecting a battery string for pre-charging (block 210). For example, the battery pack controller 108 selects a battery string (e.g., an initial battery string to be used for pre-charging). The battery pack controller 108 selects, using one or more selection criteria, a first battery string 114, from the multiple battery strings 114, for a pre-charge operation of the battery pack 100. The one or more selection criteria may use, or be based on, the pre-charging information. Additionally, or alternatively, the one or more selection criteria may be based on a battery operation to be performed by the battery pack 100 (e.g., a battery operation for which pre-charging is being performed).

For example, the battery operation may be a discharging operation. In such examples, the one or more selection criteria include a high voltage criterion. The high voltage criterion may indicate that the battery pack controller 108 is to select the battery string 114 having the highest voltage. For example, the battery pack controller 108 compares voltage levels of battery strings 114 available for pre-charging (e.g., battery strings 114 that have not already experienced a pre-charging failure, as described elsewhere herein). The battery pack control 108 may select the battery string 114, from multiple battery strings 114, that has the highest voltage level to be used for pre-charging. As another example, the battery operation may be a charging operation. In such examples, the one or more selection criteria may include a low voltage criterion. The low voltage criterion indicates that the battery pack controller 108 is to select the battery string 114 having the lowest voltage. For example, the battery pack controller 108 compares voltage levels of battery strings 114 available for pre-charging (e.g., battery strings 114 that have not already experienced a pre-charging failure, as described elsewhere herein). The battery pack control 108 may select the battery string 114, from multiple battery strings 114, that has the lowest voltage level to be used for pre-charging.

As another example, the one or more selection criteria may include a comparison of voltage levels of battery strings 114 to a voltage level of the component 112 (e.g., a load voltage level). For example, the battery pack controller 108 may select a battery string 114 based on a difference between a voltage level of the battery string 114 and a voltage level of the component 112 satisfying a threshold. For example, the battery pack controller 108 may select a battery string 114 for pre-charging based on the voltage level of the battery string 114 being within a certain amount of the voltage level of the component 112. If the voltage level of the component 112 is used as a selection criterion, then additional considerations may be used when selecting additional battery strings 114 for the pre-charge operation, as described elsewhere herein. As used herein, satisfying a threshold may, depending on the context, refer to a value being greater than the threshold, greater than or equal to the threshold, less than the threshold, less than or equal to the threshold, equal to the threshold, or not equal to the threshold.

The battery pack controller 108 attempts to pre-charge the selected battery string 114 (e.g., that is selected at block 210). The pre-charge operation 200 includes closing a contactor of a pre-charge circuit of the selected battery string 114 (block 215). The battery pack controller 108 closes the contactor of the pre-charge circuit of the selected battery string 114. For example, the battery pack controller 108 provides a command indicating that the contactor of the pre-charge circuit is to be closed (e.g., to cause the contactor of the pre-charge circuit to be closed).

The battery pack controller 108 determines whether the pre-charge operation for the selected battery string 114 is successful after closing the contactor of the pre-charge circuit (block 220). For example, the battery pack controller 108 evaluates one or more pre-charging criteria after closing the contactor. The one or more pre-charging criteria may include a voltage criterion (e.g., indicating that a voltage level of the component 112 and the voltage level of the battery string 114 are approximately the same), a current criterion (e.g., the current in the pre-charge circuit should approach zero during the pre-charge operation 200), and/or a time criterion (e.g., the pre-charge operation may be designed to occur over a certain amount of time and the pre-charge operation completing faster or slower than the certain amount of time may indicate an issue), among other examples. For example, the battery pack controller 108 determines whether voltage is balanced and stabilized across the selected battery string 114 and the component 112. Additionally, the battery pack controller 108 may determine whether an amount of time from closing the contactor of the pre-charge circuit satisfies a time threshold.

In some examples, the battery pack controller 108 determines whether the pre-charge operation for the selected battery string 114 is successful after closing the contactor of the pre-charge circuit and before closing one or more contactors of the battery string 114. For example, the battery pack controller 108 may evaluate the one or more pre-charging criteria with the contactor of the pre-charge circuit closed and the contactors of the battery string 114 open. If the one or more pre-charging criteria are not met, then the battery pack controller 108 may close a contactor of the battery string 114 (e.g., a negative contactor of the battery string 114). The battery pack controller 108 determines whether the pre-charge operation for the selected battery string 114 is successful after closing the contactor of the pre-charge circuit and after closing the negative contactor of the battery string 114.

In some examples, if the pre-charge operation for the selected battery string 114 is successful (block 220—Yes), then the pre-charge operation 200 includes closing one or more contactors of the selected battery string 114 (block 225). For example, the battery pack controller 108 provides a command indicating that one or more contactors of the selected battery string 114 are to be closed. The battery pack controller 108 may cause a positive contactor of the selected battery string 114 to be closed (e.g., to close an electrical connection between the battery string 114 and the component 112). For example, the battery pack controller 108 determines that the pre-charge operation of the selected battery string 114 is successful based on a voltage being balanced between the battery string 114 and the component 112, a current in the pre-charge circuit approaching zero, and/or an amount of time during which the pre-charging is occurring being less than or equal to a time threshold.

In some other examples, the battery pack controller 108 detects a failure of the pre-charge operation via the pre-charge circuit of a battery string 114 (e.g., the selected battery string 114). For example, if the pre-charge operation for the selected battery string 114 is not successful (block 220—No), then the process 200 includes determining whether one or more failure conditions are met (block 230). The one or more failure conditions may be indicative of scenarios in which continued pre-charging of the selected battery string 114 and/or of other battery strings 114 has a high likelihood of causing damage to components of the selected battery string 114 and/or the other battery strings 114.

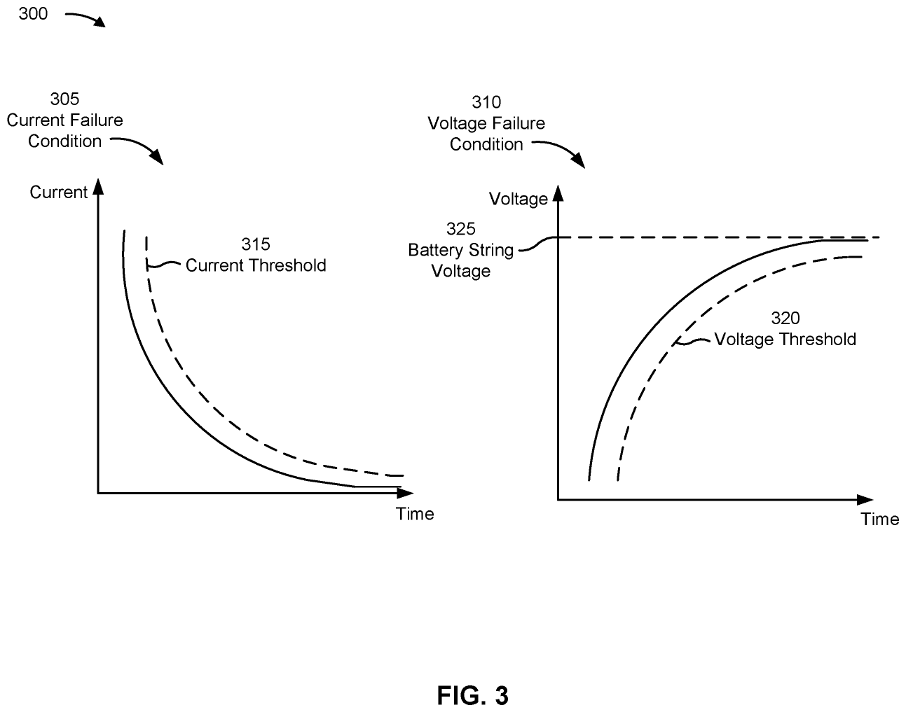

For example, the one or more failure conditions include a rate of electric charge of the pre-charge operation via the selected battery string 114 satisfying one or more thresholds. The rate of electric charge may include a voltage rate and/or a current rate during the pre-charge operation of the selected battery string 114. For example, during the pre-charge operation of the selected battery string 114, the battery pack controller 108 (or a pre-charge controller of the selected battery string 114) monitors the voltage and current of the pre-charge circuit. The one or more thresholds may define bounds for normal voltage levels and/or current levels during the pre-charge operation over a given amount of time (e.g., as depicted and described in more detail in connection with FIG. 3). For example, during successful pre-charge operations, the voltage of the component 112 may merge slowly with the voltage of the battery string 114 and the current may drop to zero (or near zero) over the duration of the pre-charge operation. However, there may be a voltage difference between the component 112 and the battery string 114, such as if there are other components or accessories of the component 112 extracting current during the pre-charge operation. In such examples, the current of the pre-charge circuit during pre-charging will not drop to zero (e.g., and will only drop to the level of current being extracted). Such scenarios may result in damage to the pre-charge circuit, such as to one or more resistors of the pre-charge circuit.

Therefore, the one or more failure conditions include a voltage level of the pre-charge circuit satisfying a voltage threshold over the duration of the pre-charge operation. Additionally, the one or more failure conditions include whether a current level of the pre-charge circuit satisfying a current threshold over the duration of the pre-charge operation. If the voltage level becomes less than or equal to the voltage threshold at a given point during the pre-charge operation (e.g., for a certain duration) and/or the current level becomes greater than or equal to the current threshold at a given point during the pre-charge operation (e.g., for a certain duration), then the one or more failure conditions are met. The one or more thresholds (e.g., the voltage threshold and/or the current threshold) may be defined based on normal pre-charge levels over the duration of the pre-charge operation. Additionally, the one or more thresholds (e.g., the voltage threshold and/or the current threshold) may be defined based on sensor accuracy levels of sensors included in the pre-charge circuit.

Additionally, or alternatively, the one or more failure conditions include a quantity of re-attempts for the pre-charge operation satisfying a re-attempt threshold. For example, the battery pack controller 108 maintains a counter indicating the quantity of retries or re-attempts of the pre-charge operation (or the quantity of failures of the pre-charge operation). Each time the battery pack controller 108 re-attempts or retires the pre-charge operation using a different battery string 114, the battery pack controller 108 increments the counter. If a pre-charge operation is successful (e.g., as described in connection with the block 220), then the battery pack controller 108 may reset the counter. If a value of the counter is greater than or equal to the re-attempt threshold, then the one or more failure conditions are met. If the value of the counter is less than or equal to the re-attempt threshold, then the one or more failure conditions are not met.

For example, the one or more failure conditions enable the battery pack controller 108 to identify scenarios in which the pre-charge operation should not be retried using other battery strings 114 (e.g., to mitigate a risk of damaging components of the other battery strings 114). For example, if the one or more failure conditions are met (block 230—Yes), then the battery pack controller 108 terminates the pre-charge operation (block 235). For example, the battery pack controller 108 provides an indication of a fault or failure of the pre-charge operation. The battery pack controller 108 refrains from attempting to perform the pre-charge operation 200 via other battery strings 114.

If the one or more failure conditions are not met (block 230—No), then the pre-charge operation 200 includes refraining from bringing the failed battery string 114 online (block 240). A “failed” battery string 114 refers to a battery string 114 for which pre-charging was attempted, but not successful, as described in more detail elsewhere herein. The battery pack controller 108 isolates and/or refrains from configuring the failed battery string 114 for operation. For example, the battery pack controller 108 refrains from closing one or more contactors of the failed battery string 114. Examples of failures for which the pre-charge operation may be retried using another battery string 114 include an issue with a contactor of the pre-charge circuit (e.g., the contactor of the pre-charge circuit being stuck open), and/or a sensor issue with the pre-charge circuit (e.g., a failure associated with a voltage sensor of the pre-charge circuit or a current sensor of the pre-charge circuit), among other examples.

If the one or more failure conditions are not met (block 230—No), then the pre-charge operation 200 includes selecting, using the one or more selection criteria, a second battery string, from the multiple battery strings, for the pre-charge operation (block 210). For example, the battery pack controller 108 selects a second battery string 114 for pre-charging if the failure does not meet or satisfy the one or more failure conditions, where the selection of the battery string is in a similar manner as described in connection with the block 210. In such examples, the one or more selection criteria include a voltage difference between the first battery string 114 (e.g., the failed battery string 114) and the second battery string (e.g., selected for a re-attempt or retry of the pre-charge operation) satisfying a threshold. For example, the battery pack controller 108 selects another battery string 114 for a re-attempt or retry of the pre-charge operation that is close to a voltage level of the previously failed battery string 114.

The pre-charge operation 200 includes performing, using a pre-charge circuit of the second battery string 114, the pre-charge operation, in a similar manner as described herein, such as in connection with the block 215, the block 220, the block 225, the block 230, the block 235, and/or the block 240. For example, the battery pack controller 108 attempts to perform (e.g., retries or re-attempts) the pre-charge operation using another battery string 114 (e.g., that is selected using the one or more selection criteria).

For example, the battery pack controller 108 performs a first re-attempt operation, using a second battery string of the multiple battery strings, for the pre-charge operation based on a first failure (e.g., of a previously selected battery string 114) meeting or satisfying the one or more failure conditions. The battery pack controller 108 may delay an initiation of the pre-charge operation for an amount of time from a time at which the previous failure is detected (e.g., at block 220). For example, there may be a wait time between re-attempts of the pre-charge operation. Delaying the initiation of a re-attempt of the pre-charge operation via another battery string 114 mitigates a risk of damage to components of the battery pack 100 and/or the component 112 that may otherwise be caused by rapid changes in which pre-charge circuits are connected or disconnected.

In some examples, the battery pack controller 108 detects a second failure of the pre-charge operation via the second battery string (e.g., at the block 220). The battery pack controller 108 performs a second re-attempt operation, using a third battery string of the multiple battery strings, for the pre-charge operation based on the second failure satisfying the one or more failure conditions (e.g., at the block 230). In other words, the battery pack controller 108 continues to re-attempt or retry the pre-charge operation via different battery strings using the one or more selection criteria to select a next battery string 114 and using the one or more failure conditions to determine whether another re-attempt should be performed.

The pre-charge operation 200 includes bringing the battery string 114 (e.g., for which the pre-charge operation was successfully performed) and any failed battery strings 114 online (block 245). For example, the battery pack controller 108 brings the battery string 114 (e.g., for which the pre-charge operation was successfully performed) and any failed battery strings 114 online. The battery pack controller 108 maintains a list of battery strings that have been isolated and/or not brought online due to failed pre-charging (e.g., at the block 240). In some examples, the pre-charging is successful via another battery string 114, then the battery pack controller may configure the failed battery string(s) 114 for operation. The battery pack controller 108 may configure the failed battery string(s) 114 for operation with a mitigated risk of damage to components of the failed battery string(s) 114 because the battery string 114 (e.g., for which the pre-charge operation was successfully performed) is selected using the one or more selection criteria and is selected only if the one or more failure conditions are not met. This may improve a likelihood that the failed battery string(s) 114 can be brought online without pre-charging and/or without damaging components of the failed battery string(s) 114.

For example, the battery pack controller 108 may configure a failed battery string 114 in a connected state (e.g., with contactors of the battery string 114 closed) with a pre-charge contactor of the pre-charge circuit of the failed battery string 114 being configured in an open position. In other words, the battery pack controller 108 brings the failed battery string 114 online without pre-charging the failed battery string 114 and/or without closing the pre-charge contactor of the failed battery string 114. For example, the battery pack controller 108 may use the pre-charging performed via another battery string 114 to safely bring the failed battery string(s) online. For example, because the voltage of the component 112 may be safely brought to a level of the voltage of a battery string 114 (e.g., that is selected using the one or more selection criteria), then the battery pack controller 108 may safely bring any failed battery strings 114 online (e.g., by closing contactors of the failed battery string(s)).

In some examples, the battery pack controller 108 performs, using a pre-charge circuit of a failed battery string 114, the pre-charge operation based on, or in response to, successfully performing the pre-charge operation using another battery string 114. For example, the battery pack controller 108 may retry pre-charging for a failed battery string 114 based on, or in response to, successfully completing pre-charging using another battery string 114, as described herein. The battery pack controller 108 configures the failed battery string 114 in a connected state (e.g., by closing the contactors of the battery string 114) if the retry of the pre-charge operation via the battery string is successful.

The pre-charge operation 200 optionally includes determining whether all battery strings 114 (included in the battery pack 100) are online (block 250). If all battery strings 114 of the battery pack 100 are not online (block 250—No), then the pre-charge operation 200 may include selecting another battery string 114 (e.g., from the battery string(s) 114 that are not online) for pre-charging, as described in connection with block 210. The pre-charge operation 200 may follow a similar process as described herein until all battery strings 114 of the battery pack 100 are online (e.g., have the contactors of the battery strings 114 closed). If all battery strings 114 of the battery pack 100 are online (block 250—Yes), then the pre-charge operation 200 include performing one or more battery operations (block 255). For example, the battery pack controller 108 may perform one or more battery operations via the battery strings 114 based on safely bringing the battery strings 114 online via the pre-charge operation 200, as described herein.

In other implementations, if the pre-charge operation is successful, then the pre-charge operation 200 includes configuring one or more (or all) other battery strings 114 for operation (e.g., because the sequencing criteria is fulfilled based on the pre-charge operation being successful). In other words, the pre-charge operation 200 includes configuring one or more (or all) other battery strings 114 for operation without pre-charging the other battery strings 114.

As indicated above, FIG. 2 is provided as an example. Other examples may differ from what is described with regard to FIG. 2.

FIG. 3 is a diagram of an example of one or more failure conditions 300. As described elsewhere herein, the one or more failure conditions may be used (e.g., by the battery pack controller 108) to determine whether to retry or re-attempt pre-charging for the battery pack 100 after a failure of a pre-charge operation using a battery string 114 using a different battery string 114.

The one or more failure conditions 300 include a current failure condition 305 and a voltage failure condition 310. The current failure condition 305 defines an acceptable current rate (e.g., rate of change of the current in a pre-charge circuit) for a pre-charge operation. For example, a current threshold 315 is defined. The current threshold 315 defines current levels over time (e.g., over a duration of a pre-charge operation). The current threshold 315 may be based on normal or expected current levels during the pre-charge operation, as shown by the solid line in the graph for the current failure condition 305. For example, if a current in a pre-charge circuit is greater than or equal to the current threshold 315 at a given time during the pre-charge operation, then the one or more failure conditions 300 are met, as described elsewhere herein. In some implementations, if a duration for which the current in a pre-charge circuit is greater than or equal to the current threshold 315 satisfies a threshold (e.g., a duration threshold), then the one or more failure conditions 300 are met, as described elsewhere herein.

The voltage failure condition 310 defines an acceptable voltage rate (e.g., a rate of change of the voltage of the component 112, a load-side voltage, or a machine side voltage) for a pre-charge operation. For example, a voltage threshold 320 is defined. The voltage threshold 320 defines voltage levels over time (e.g., over a duration of a pre-charge operation). The voltage threshold 320 may be based on normal or expected voltage levels during the pre-charge operation, as shown by the solid line in the graph for the voltage failure condition 310. For example, a voltage level of the component 112 is expected to approach a battery string voltage 325 of a battery string 114 being used for the pre-charge operation. If the voltage level of the component 112 is less than or equal to the voltage threshold 320 at a given time, then he one or more failure conditions 300 are met, as described elsewhere herein. In some implementations, if a duration for which the voltage level of the component 112 is less than or equal to the voltage threshold 320 satisfies a threshold (e.g., a duration threshold), then the one or more failure conditions 300 are met, as described elsewhere herein.

As indicated above, FIG. 3 is provided as an example. Other examples may differ from what is described with regard to FIG. 3.

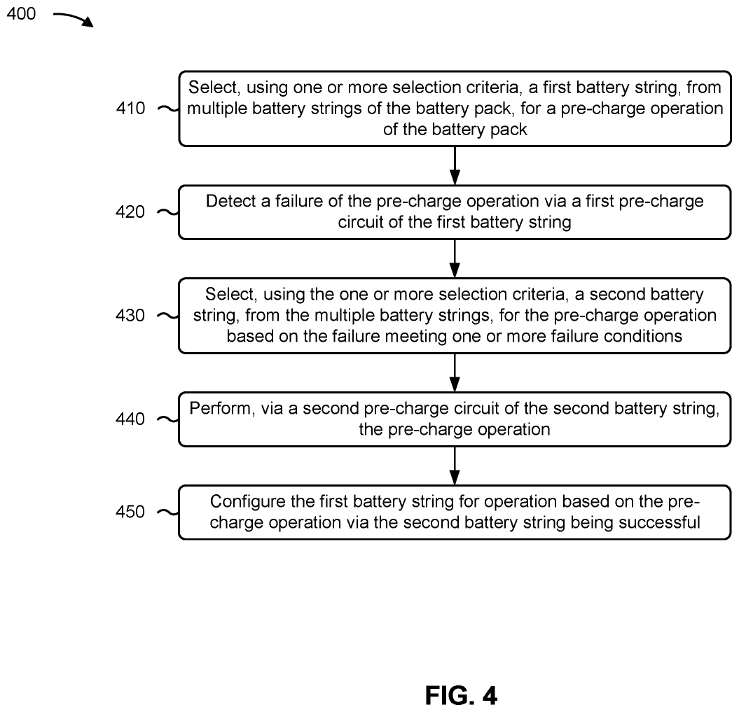

FIG. 4 is a flowchart of an example process 400 associated with a battery string pre-charge operation. One or more process blocks of FIG. 4 may be performed by a controller (e.g., the battery pack controller 108). Additionally, or alternatively, one or more process blocks of FIG. 4 may be performed by another device or a group of devices separate from or including the controller, such as another device or component that is internal or external to the battery pack 100.

As shown in FIG. 4, process 400 may include selecting, using one or more selection criteria, a first battery string, from multiple battery strings of the battery pack, for a pre-charge operation of the battery pack (block 410). For example, the controller may select, using one or more selection criteria, a first battery string, from multiple battery strings of the battery pack, for a pre-charge operation of the battery pack, as described above. The one or more selection criteria include a voltage criterion that is based on a battery operation for which the pre-charge operation is being performed.

As further shown in FIG. 4, process 400 may include detecting a failure of the pre-charge operation via a first pre-charge circuit of the first battery string (block 420). For example, the controller may detect a failure of the pre-charge operation via a first pre-charge circuit of the first battery string, as described above.

As further shown in FIG. 4, process 400 may include selecting, using the one or more selection criteria, a second battery string, from the multiple battery strings, for the pre-charge operation based on the failure meeting one or more failure conditions (block 430). For example, the controller may select, using the one or more selection criteria, a second battery string, from the multiple battery strings, for the pre-charge operation based on the failure meeting one or more failure conditions, as described above. The one or more failure conditions include a rate of electric charge of the pre-charge operation via the first battery string satisfying one or more thresholds. The one or more failure conditions include a quantity of re-attempts for the pre-charge operation satisfying a re-attempt threshold.

As further shown in FIG. 4, process 400 may include performing, via a second pre-charge circuit of the second battery string, the pre-charge operation (block 440). For example, the controller may perform, via a second pre-charge circuit of the second battery string, the pre-charge operation, as described above.

As further shown in FIG. 4, process 400 may include configuring the first battery string for operation based on the pre-charge operation via the second battery string being successful (block 450). For example, the controller may configure the first battery string for operation based on the pre-charge operation via the second battery string being successful, as described above. Configuring the first battery string for operation includes configuring the first battery string in a connected state with a pre-charge contactor of the first pre-charge circuit being configured in an open position.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

### INDUSTRIAL APPLICABILITY

Pre-charging involves gradually applying voltage to the load, allowing the voltage of components to stabilize and reducing the impact of inrush currents (e.g., by bringing a voltage of a load close to a voltage level of the battery pack and/or one or more battery strings). By implementing a controlled pre-charge operation, the risks associated with sudden and high inrush currents can be minimized. However, in some cases, a battery pack may include a single pre-charge circuit and all battery strings may be pre-charged together. Therefore, if there is a failure of the pre-charge operation, the battery pack and/or a battery string (e.g., used for pre-charging) may not be usable until the issue that caused the failure is resolved.

Some implementations described herein enable a pre-charge operation in which battery strings can be safely brought online after experiencing a pre-charging failure. For example, a controller (e.g., the battery pack controller 108) selects, using one or more selection criteria, a first battery string, from multiple battery strings of the battery pack, for a pre-charge operation of the battery pack. Each battery string may include a pre-charge component to enable pre-charging to be performed via any battery string included in the battery pack. The controller detects a failure of the pre-charge operation via a first pre-charge circuit of the first battery string. The controller selects, using the one or more selection criteria, a second battery string, from the multiple battery strings, for the pre-charge operation based on the failure meeting one or more failure conditions. The one or more failure conditions may include a voltage failure condition and/or a current failure condition. The controller performs, via a second pre-charge circuit of the second battery string, the pre-charge operation. The controller configures the first battery string for operation based on the pre-charge operation via the second battery string being successful.

As a result, a battery string via which pre-charging was previously failed may be brought online without pre-charging the battery string. By configuring each battery string with a pre-charging component and/or pre-charge circuit, the controller may select a battery string that is best suited for pre-charging based on current load information, current battery voltage, and/or a current application or battery operation, among other examples. Because the battery strings are selected using the one or more selection criteria, if a battery string (e.g., that is selected using the one or more selection criteria) is successfully pre-charged, then the controller may determine that previously failed battery string(s) may be safely brought online without pre-charging. Additionally, by using the one or more failure conditions to determine whether to re-attempt the pre-charge operation using a second battery string, the controller may identify scenarios in which additional pre-charging presents a risk of damage to components of the battery pack 100. This mitigates a risk of damaging components of pre-charge circuits of other battery strings that may otherwise be caused by attempting to pre-charge the other battery strings.

What is claimed is:

1. A battery pack, comprising:
multiple battery strings having respective pre-charge circuits; and
one or more controllers configured to:
select, using one or more selection criteria, a first battery string, from the multiple battery strings, for a pre-charge operation of the battery pack;
detect a failure of the pre-charge operation via a first pre-charge circuit of the first battery string;
select, using the one or more selection criteria, a second battery string, from the multiple battery strings, for the pre-charge operation if the failure does not meet one or more failure conditions;
perform, using a second pre-charge circuit of the second battery string, the pre-charge operation; and
configure the first battery string for operation if the pre-charge operation via the second battery string is successful.

2. The battery pack of claim 1, wherein the one or more failure conditions include a rate of electric charge of the pre-charge operation via the first battery string satisfying one or more thresholds.

3. The battery pack of claim 1, wherein the one or more failure conditions include a quantity of re-attempts for the pre-charge operation satisfying a re-attempt threshold.

4. The battery pack of claim 1, wherein a battery operation of the battery pack associated with the pre-charge operation is a discharging operation, and
wherein the one or more selection criteria include a high voltage criterion.

5. The battery pack of claim 1, wherein a battery operation of the battery pack associated with the pre-charge operation is a charging operation, and
wherein the one or more selection criteria include a low voltage criterion.

6. The battery pack of claim 1, wherein the one or more controllers, to perform, using the second pre-charge circuit of the second battery string, the pre-charge operation, are configured to:
delay an initiation of the pre-charge operation for an amount of time from a time at which the failure is detected.

7. The battery pack of claim 1, wherein the one or more controllers are further configured to:
terminate the pre-charge operation if the failure meets the one or more failure conditions.

8. The battery pack of claim 1, wherein the one or more controllers, to configure the first battery string for operation, are configured to:
configure the first battery string in a connected state with a pre-charge contactor of the first pre-charge circuit being configured in an open position.

9. The battery pack of claim 1, wherein the one or more controllers, to configure the first battery string for operation, are configured to:
perform, using the first pre-charge circuit of the first battery string, the pre-charge operation; and
configure the first battery string in a connected state if the pre-charge operation via the first battery string is successful.

10. A controller for a battery pack, comprising:
one or more memories; and
one or more processors, communicatively coupled to the one or more memories, configured to:
select, using one or more selection criteria, a first battery string, from multiple battery strings of the battery pack, for a pre-charge operation of the battery pack;
detect a first failure of the pre-charge operation via the first battery string;
perform a first re-attempt operation, using a second battery string of the multiple battery strings, for the pre-charge operation based on the first failure satisfying one or more failure conditions; and
configure, if the pre-charge operation is successful via the second battery string, the first battery string and the second battery string for operation.

11. The controller of claim 10, wherein the one or more processors are further configured to:
select the second battery string using the one or more selection criteria.

12. The controller of claim 11, wherein the one or more selection criteria include a voltage difference between the first battery string and the second battery string satisfying a threshold.

13. The controller of claim 10, wherein the one or more processors are further configured to:
detect a second failure of the pre-charge operation via the second battery string; and
perform a second re-attempt operation, using a third battery string of the multiple battery strings, for the pre-charge operation based on the second failure satisfying the one or more failure conditions.

14. The controller of claim 13, wherein the one or more processors are further configured to:
configure, if the pre-charge operation is successful via the third battery string, the first battery string, the second battery string, and the third battery string for operation.

15. The controller of claim 10, wherein the one or more failure conditions include at least one of:
a voltage rate of the pre-charge operation satisfying a voltage threshold, or
a current rate of the pre-charge operation satisfying a current threshold.

16. A method performed by a controller of a battery pack, comprising:
selecting, using one or more selection criteria, a first battery string, from multiple battery strings of the battery pack, for a pre-charge operation of the battery pack;
detecting a failure of the pre-charge operation via a first pre-charge circuit of the first battery string;
selecting, using the one or more selection criteria, a second battery string, from the multiple battery strings, for the pre-charge operation based on one or more failure conditions;
performing, via a second pre-charge circuit of the second battery string, the pre-charge operation; and
configuring the first battery string for operation based on the pre-charge operation via the second battery string being successful.

17. The method of claim 16, wherein the one or more failure conditions include a rate of electric charge of the pre-charge operation via the first battery string satisfying one or more thresholds.

18. The method of claim 16, wherein the one or more failure conditions include a quantity of re-attempts for the pre-charge operation satisfying a re-attempt threshold.

19. The method of claim 16, wherein the one or more selection criteria include a voltage criterion that is based on a battery operation for which the pre-charge operation is being performed.

20. The method of claim 16, wherein configuring the first battery string for operation comprises:
configuring the first battery string in a connected state with a pre-charge contactor of the first pre-charge circuit being configured in an open position.
